(19) United States
(12) Patent Application Publication
(10) Pub. No.: US 2026/0261125 A1
(43) Pub. Date: Sep. 3, 2026

(54) STORAGE BATTERY SYSTEM

(71) Applicant: TMEIC Corporation, Tokyo (JP)

(72) Inventor: Kazuki KIYOTA, Chuo-ku (JP)

(73) Assignee: TMEIC Corporation, Tokyo (JP)

(21) Appl. No.: 19/163,884

(22) PCT Filed: Feb. 13, 2024
(86) PCT No.: PCT/JP2024/004772

§ 371 Date: Sep. 10, 2025

(51) Int. Cl. H02J 3/175; H02J 3/001; H02J 3/32; H02J 7/00; H02J 7/50; H02J 7/82; H02J 7/90; H02J 9/06

(52) U.S. Cl. CPC H02J 3/175; H02J 3/001; H02J 3/32; H02J 7/50; H02J 7/82; H02J 7/855; H02J 7/933; H02J 9/062

(57) ABSTRACT

A storage battery system includes a plurality of storage battery boards and a control device that controls the plurality of storage battery boards. The storage battery board includes a switch to control connection between the storage battery board and an uninterruptible power supply device. In response to a power failure caused as power supplied to the uninterruptible power supply device from an AC input power source is interrupted, the control device controls the switch of the plurality of storage battery boards based on a magnitude of a load connected to the uninterruptible power supply device.

### TECHNICAL FIELD

The present disclosure relates to a storage battery system.

### BACKGROUND ART

A conventionally known uninterruptible power supply device normally supplies a load with power received from an AC power source and in response to a power failure supplies the load with power received from a storage battery (for example, see PTL 1). The storage battery having power consumed in response to the power failure is charged at a normal time with power received from the AC power source.

### CITATION LIST

### Patent Literature

PTL 1: Japanese Patent Laying-Open No. 2021-040398

### SUMMARY OF INVENTION

### Technical Problem

When a storage battery is electrically discharged in response to a power failure more than necessary, it will take a long period of time to electrically charge the storage battery at a normal time.

Therefore, an object of the present disclosure is to provide a storage battery system capable of reducing an amount of power discharged in response to a power failure.

### Solution to Problem

The presently disclosed storage battery system comprises a plurality of storage battery boards and a control device that controls the plurality of storage battery boards. The storage battery board comprises a switch to control connection between the storage battery board and the power supply device. In response to a power failure caused as power supplied to the power supply device from an external power source is interrupted, the control device controls the switch of the plurality of storage battery boards based on a magnitude of a load connected to the power supply device.

### Advantageous Effects of Invention

According to the present disclosure, the control device can control a switch of a plurality of storage battery boards in response to a power failure, based on a magnitude of a load connected to a power supply device, and thus reduce an amount of power discharged in response to the power failure.

### BRIEF DESCRIPTION OF DRAWINGS

FIG. 1 is a diagram illustrating a configuration of a power supply system according to a first embodiment.

FIG. 2 is a diagram illustrating a configuration of a storage battery system 10.

FIG. 3 is a functional block diagram of a control device 12E of a reference example.

FIG. 4 is a functional block diagram of a control device 12 according to the first embodiment.

FIG. 5 is a graph representing a relationship between a system discharge current Is and a committed number L.

FIG. 6 is a functional block diagram of a control device 12A according to a second embodiment.

FIG. 7 is a functional block diagram of a control device 12B according to a third embodiment.

FIG. 8 is a functional block diagram of a control device 12C according to a fourth embodiment.

FIG. 9 is a diagram illustrating a configuration of a power supply system according to a fifth embodiment.

FIG. 10 is a functional block diagram of a control device 12D according to the fifth embodiment.

### DESCRIPTION OF EMBODIMENTS

Hereinafter, embodiments will be described with reference to the drawings.

### First Embodiment

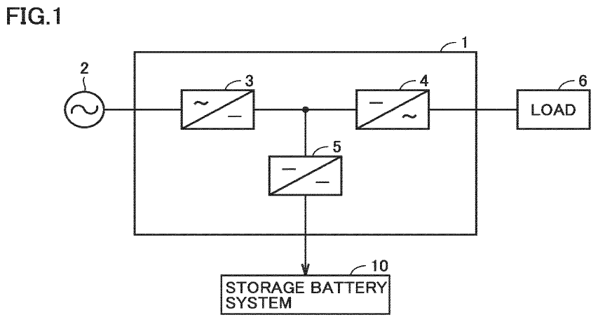

FIG. 1 is a diagram illustrating a configuration of a power supply system according to a first embodiment.

The power supply system comprises an AC input power source 2, an uninterruptible power supply device 1, a load 6, and a storage battery system 10.

Uninterruptible power supply device 1 is connected to AC input power source 2, which is an external power source, and load 6. AC input power source 2 supplies AC power to uninterruptible power supply device 1. AC input power source 2 is configured for example by a commercial AC power source, a private power generator, or the like.

Uninterruptible power supply device 1 comprises a converter 3, an inverter 4, and a chopper circuit 5. Converter 3 and inverter 4 are connected in series between AC input power source 2 and load 6. Converter 3 receives AC voltage from AC input power source 2 and converts the received AC voltage to DC voltage. Inverter 4 receives the DC voltage from converter 3 and converts the received DC voltage to AC voltage.

Chopper circuit 5 converts the DC voltage in level in voltage and supplies it to storage battery system 10. Storage battery system 10 is connected to converter 3 in parallel with inverter 4 via chopper circuit 5.

Normally when AC power is received from AC input power source 2, converter 3 generates DC voltage which is in turn stored in storage battery system 10 via chopper circuit 5 and is also converted to AC voltage by inverter 4 and supplied to load 6. On the other hand, when the AC voltage supplied from AC input power source 2 is interrupted and a power failure thus occurs, converter 3 is stopped from operating.

The DC voltage stored in storage battery system 10 is sent to inverter 4 via chopper circuit 5, converted to AC voltage by inverter 4, and thus supplied to load 6. Thus, even when a power failure occurs, uninterruptible power supply device 1 allows load 6 to continue to operate using the power stored in storage battery system 10.

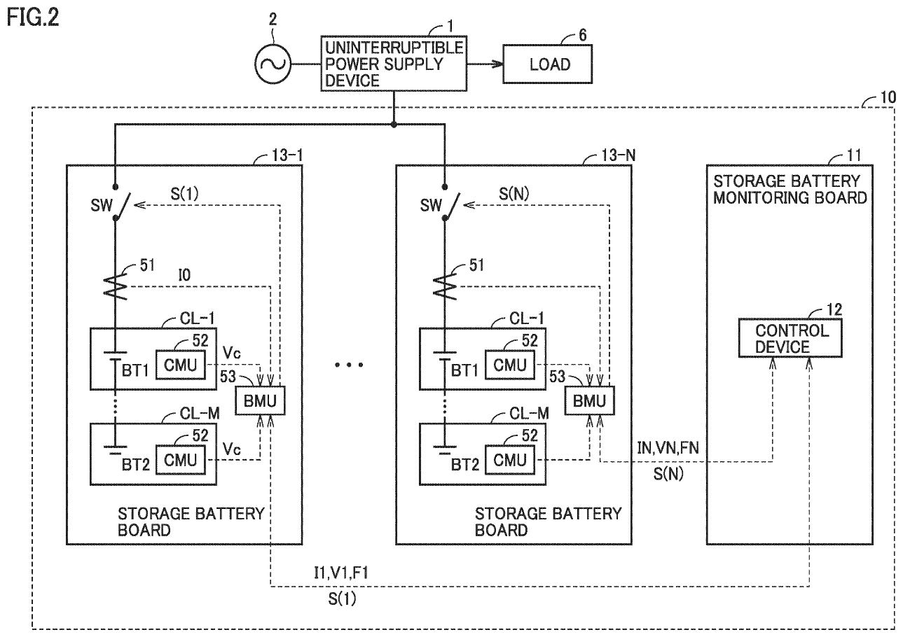

FIG. 2 is a diagram illustrating a configuration of storage battery system 10.

Storage battery system 10 comprises N storage battery boards 13-1 to 13-N and a storage battery monitoring board 11. In the following description, storage battery boards 13-1 to 13-N may be collectively referred to as a storage battery board 13.

Storage battery board 13-i (where i=1 to N) comprises M cells CL-1 to CL-M, a current detector 51, a switch SW, and a BMU (Battery Management Unit) 53. In the following description, cells CL-1 to CL-M may be referred to as a cell CL representatively.

When switch SW is turned on, storage battery board 13-i is connected to uninterruptible power supply device 1. When a switch signal S(i) goes to the high level, switch SW is turned on (or closed). When switch signal S(i) falls to the low level, switch SW is turned off (or opened).

Current detector 51 detects a current (a discharged current) Ii flowing from storage battery board 13-i to uninterruptible power supply device 1 when switch SW is turned on. Current detector 51 transmits the detected current Ii to BMU 53.

Cell CL includes a lithium ion battery BT and a cell monitoring unit (CMU) 52.

CMU 52 measures a voltage Vc (or cell voltage) of lithium ion battery BT and transmits it to BMU 53.

BMU 53 detects a failure of storage battery board 13 based on voltage Vc, current Ii, or the like. BMU 53 calculates a sum of voltages Vc of M lithium ion batteries BT as a voltage Vi of storage battery board 13. BMU 53 transmits current Ii, voltage Vi, and failure information Fi of storage battery board 13 to a control device 12 of storage battery monitoring board 11.

Storage battery monitoring board 11 comprises control device 12. Control device 12 comprises a CPU (Central Processing Unit) and a memory. The CPU controls storage battery boards 13-1 to 13-N by executing a program stored in the memory.

Control device 12 receives current Ii, voltage Vi, and failure information Fi from BMUs 53 of N storage battery boards 13-i. When power supplied from an external power source, or AC input power source 2, to uninterruptible power supply device 1 is interrupted and a power failure thus occurs, control device 12 controls switches SW of N storage battery boards 13-1 to 13-N based on a magnitude of load 6 connected to uninterruptible power supply device 1.

### (Control Device of Reference Example)

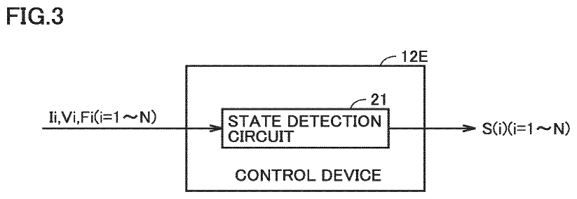

Initially, a control device 12E of a reference example will be described. FIG. 3 is a functional block diagram of control device 12E of the reference example. Control device 12E comprises a state detection circuit 21.

State detection circuit 21 detects a state of storage battery board 13-i based on at least one of voltage Vi, current Ii, and failure information Fi sent from BMU 53 of storage battery board 13-i (where i=1 to N). For example, state detection circuit 21 detects that storage battery board 13-i is abnormal when voltage Vi sent from BMU 53 of storage battery board 13-i and an average value of N voltages V1 to VN sent from BMUs 53 of storage battery boards 13-1 to 13-N have a difference equal to or larger than a threshold value. Alternatively, state detection circuit 21 detects that storage battery board 13-i is abnormal when current Ii sent from BMU 53 of storage battery board 13-i and an average value of N currents I1 to IN sent from BMUs 53 of storage battery boards 13-1 to 13-N have a difference equal to or larger than a threshold value. Alternatively, state detection circuit 21 detects that storage battery board 13-i is abnormal when failure information Fi sent from BMU 53 of storage battery board 13-i represents a failure.

State detection circuit 21 sets switch signal S(i) to the high level for a normal storage battery board 13-i. State detection circuit 21 sets switch signal S(i) to the low level for an abnormal storage battery board 13-i.

In the reference example, when a power failure occurs, each storage battery board has it switch continuously closed insofar as the storage battery board has no abnormality, and the storage battery system performs discharging beyond a specified time even for a small load. As a result, it takes a long period of time to charge the storage battery system after power restoration.

### (Control Device of First Embodiment)

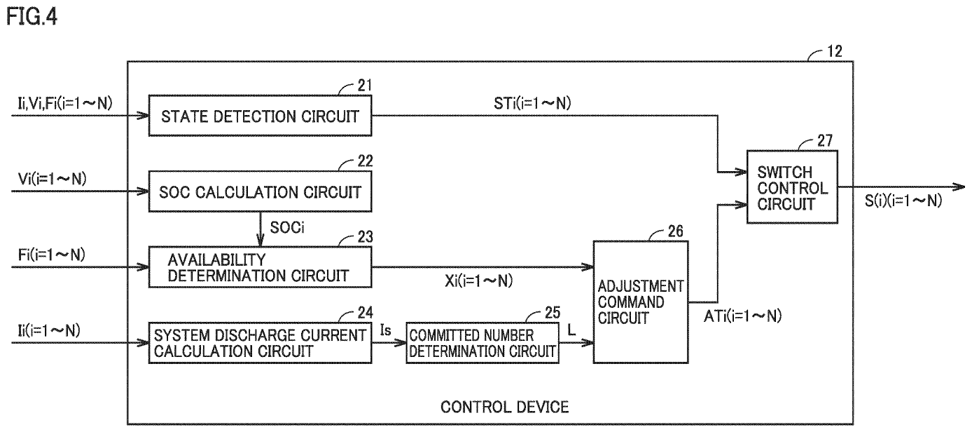

Control device 12 of the first embodiment will now be described. FIG. 4 is a functional block diagram of control device 12 according to the first embodiment. Control device 12 comprises state detection circuit 21, an SOC (States of Charge) calculation circuit 22, an availability determination circuit 23, a system discharge current calculation circuit 24, a committed number determination circuit 25, an adjustment command circuit 26, and a switch control circuit 27.

As well as the reference example, state detection circuit 21 detects a state of storage battery board 13-i based on at least one of voltage Vi, current Ii, and failure information Fi transmitted from BMU 53 of storage battery board 13-i (where i=1 to N). State detection circuit 21 sets a commitment command signal STi to the high level for a normal storage battery board 13-i. State detection circuit 21 sets commitment command signal STi to the low level for an abnormal storage battery board 13-i.

SOC calculation circuit 22 calculates an SOCi of storage battery board 13-i based on voltage Vi and the like sent from BMU 53 of storage battery board 13-i (where i=1 to N). SOC calculation circuit 22 may calculate the SOCi of storage battery board 13-i based on an average value of voltages Vc of M lithium ion batteries BT of storage battery board 13-i.

When failure information Fi of storage battery board 13-i represents normality and storage battery board 13-i has an SOCi equal to or larger than a threshold value, availability determination circuit 23 determines that storage battery board 13-i is available. When failure information Fi of storage battery board 13-i indicates a failure or storage battery board 13-i has an SOC-i smaller than the threshold value, availability determination circuit 23 determines that storage battery board 13-i is unavailable.

Availability determination circuit 23 sets an availability signal Xi to the high level for an available storage battery board 13-i. Availability determination circuit 23 sets availability signal Xi to the low level for an unavailable storage battery board 13-i.

System discharge current calculation circuit 24 calculates a sum of currents I1 to IN sent from BMUs 53 of storage battery boards 13-1 to 13-N as a system discharge current Is. The magnitude of system discharge current Is represents the magnitude of load 6 connected to uninterruptible power supply device 1. The larger system discharge current Is is, the larger load 6 is.

Committed number determination circuit 25 determines a number L of storage battery boards to be committed based on system discharge current Is. As system discharge current Is increases, committed number determination circuit 25 increases stepwise the number of storage battery boards to be committed.

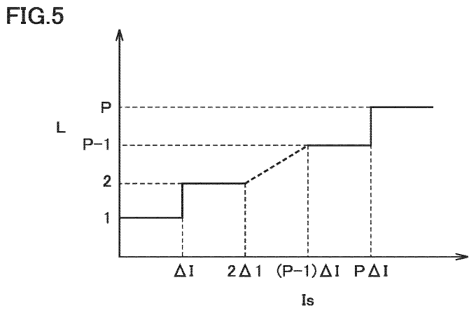

FIG. 5 is a graph representing a relationship between system discharge current Is and committed number L. As shown in FIG. 5, whenever system discharge current Is increases by AI, the committed number increases by one.

Adjustment command circuit 26 determines storage battery board 13 to be held committed based on number L of storage battery boards to be committed and availability signal Xi for storage battery board 13-i (where i=1 to N). Adjustment command circuit 26 calculates a total number R of available storage battery boards 13 based on availability signal Xi (where i=1 to N). When total number R of available storage battery boards 13 is equal to or larger than number L of storage battery boards to be committed, adjustment command circuit 26 determines any L storage battery boards 13 from R available storage battery boards 13 as storage battery boards to be held committed, and determines any other storage battery board as a storage battery board which is not to be held committed. Adjustment command circuit 26 sets an adjustment command signal ATi to the high level for storage battery board 13-i to be held committed. Adjustment command circuit 26 sets adjustment command signal ATi to the low level for storage battery board 13-i which is not to be held committed.

Adjustment command circuit 26 sets adjustment command signals AT1 to ATN to the high level for storage battery boards 13-1 to 13-N when total number R of available storage battery boards 13 is smaller than number L of storage battery boards to be committed.

Switch control circuit 27 sets switch signal S(i) to the high level when commitment command signal STi is at the high level and adjustment command signal ATi is at the high level. Switch control circuit 27 sets switch signal S(i) to the low level when commitment command signal STi is at the low level or adjustment command signal ATi is at the low level.

As described above, according to the present embodiment, each storage battery board can have a switch closed as controlled to adjust a discharging time for a small load to match a specified time. This can reduce a total amount of power discharged by storage battery boards in response to a power failure, and hence a charging time consumed after power restoration.

### Second Embodiment

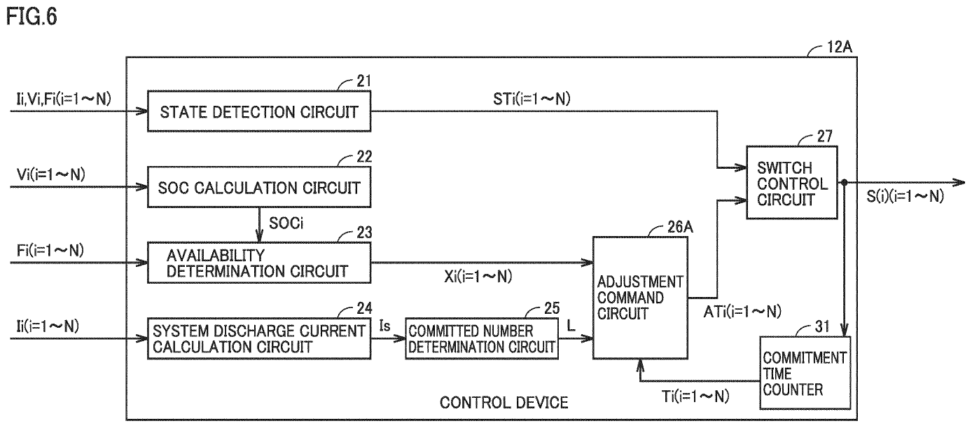

FIG. 6 is a functional block diagram of a control device 12A according to a second embodiment. Control device 12A according to the second embodiment is different from control device 12 according to the first embodiment in that control device 12A according to the second embodiment comprises a commitment time counter 31 and an adjustment command circuit 26A instead of adjustment command circuit 26.

Commitment time counter 31 counts a cumulative value Ti of commitment time of storage battery board 13-i in response to a power failure (or a period of time for which switch SW is turned on). For example, when there are three power failures up to the present since uninterruptible power supply device 1 was brought into service, and storage battery board 13-1 was committed for 10 minutes, 0 minute and 5 minutes for the first, second and third power failures, respectively, storage battery board 13-1 was committed for 15 minutes in total. For example, commitment time counter 31 can count cumulative value Ti of commitment time of storage battery board 13-i (or a period of time for which switch SW is turned on) by counting a time when switch signal S(i) goes to the high level in response to a power failure.

Adjustment command circuit 26A determines storage battery board 13 to be held committed, based on number L of storage battery boards to be committed, availability signal Xi for storage battery board 13-i (where i=1 to N), and cumulative value Ti of commitment time of storage battery board 13-i (where i=1 to N). Adjustment command circuit 26A calculates total number R of available storage battery boards 13 based on availability signal Xi (where i=1 to N). When total number R of available storage battery boards 13 is equal to or larger than number L of storage battery boards to be committed, adjustment command circuit 26 determines from R available storage battery boards 13 as storage battery boards to be held committed L storage battery boards 13 having commitment time having smaller cumulative values T in an ascending order, and determines any other storage battery board as a storage battery board which is not to be held committed. Adjustment command circuit 26A sets adjustment command signal ATi to the high level for storage battery board 13-i to be held committed. Adjustment command circuit 26A sets adjustment command signal ATi to the low level for storage battery board 13-i which is not to be held committed.

Adjustment command circuit 26A sets adjustment command signals AT1 to ATN to the high level for storage battery boards 13-1 to 13-N when total number R of available storage battery boards 13 is smaller than number L of storage battery boards to be committed.

Thus, according to the present embodiment, the storage battery boards can be equally deteriorated as, of the storage battery boards, a storage battery board having an SOC equal to or larger than a threshold value and having commitment time having a smaller cumulative value in response to power failure is preferentially caused to supply power. A cumulative value of commitment time of a storage battery board may be replaced with how many times the storage battery board is committed.

### Third Embodiment

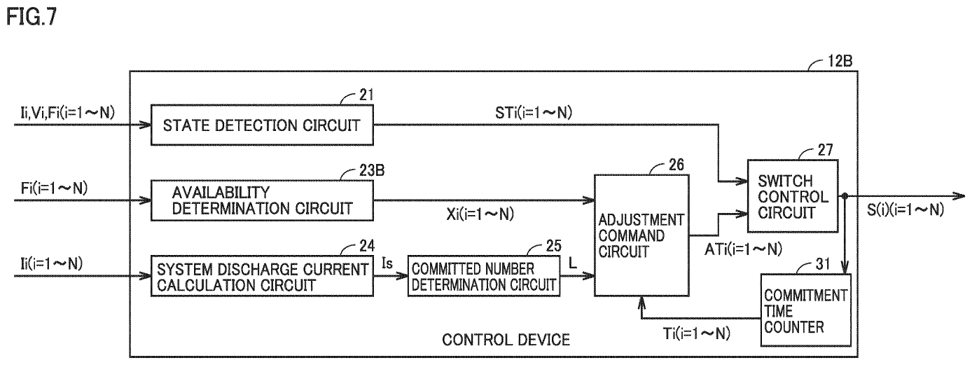

FIG. 7 is a functional block diagram of a control device 12B according to a third embodiment. Control device 12B according to the third embodiment is different from control device 12A according to the second embodiment in that control device 12B according to the third embodiment dispenses with SOC calculation circuit 22 and comprises an availability determination circuit 23B instead of availability determination circuit 23.

When failure information Fi of storage battery board 13-i represents normality, availability determination circuit 23B determines that storage battery board 13-i is available. When failure information Fi of storage battery board 13-i indicates a failure, availability determination circuit 23B determines that storage battery board 13-i is unavailable. Availability determination circuit 23B sets availability signal Xi to the high level for an available storage battery board 13-i. Availability determination circuit 23B sets availability signal Xi to the low level for an unavailable storage battery board 13-i.

Thus, according to the present embodiment, the storage battery boards can be equally deteriorated as, of the storage battery boards, a storage battery board having commitment time having a smaller cumulative value is preferentially caused to supply power.

### Fourth Embodiment

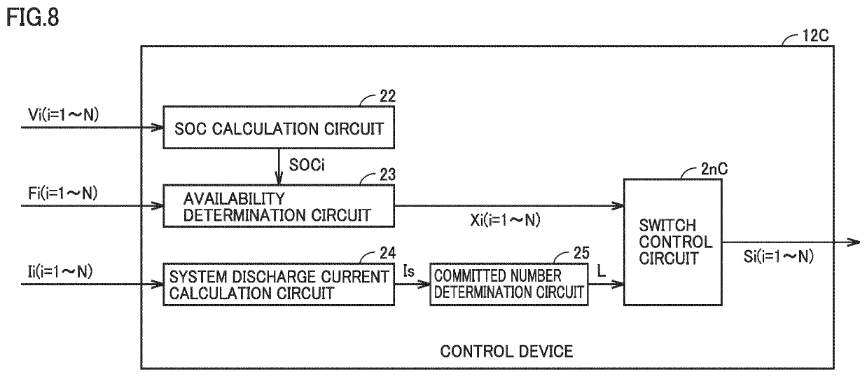

FIG. 8 is a functional block diagram of a control device 12C according to a fourth embodiment. Control device 12C of the fourth embodiment is different from control device 12 of the first embodiment in that control device 12C of the fourth embodiment dispenses with state detection circuit 21 and adjustment command circuit 26, and comprises a switch control circuit 27C instead of switch control circuit 27.

Switch control circuit 27C determines storage battery board 13 to be held committed, based on number L of storage battery boards to be committed and availability signal Xi for storage battery board 13-i (where i=1 to N). Switch control circuit 27C calculates total number R of available storage battery boards 13 based on availability signal Xi (where i=1 to N). When total number R of available storage battery boards 13 is equal to or larger than number L of storage battery boards to be committed, switch control circuit 27C determines L storage battery boards 13 from R available storage battery boards 13 as storage battery boards to be held committed, and determines any other storage battery board as a storage battery board which is not to be held committed. Switch control circuit 27C sets switch signal S(i) to the high level for storage battery board 13-i to be held committed. Switch control circuit 27C sets switch signal S(i) to the low level for storage battery board 13-i which is not to be held committed.

Switch control circuit 27C sets switch signals S(1) to S(N) to the high level for storage battery boards 13-1 to 13-N when total number R of available storage battery boards 13 is smaller than number L of storage battery boards to be committed.

As described above, in contrast to the first to third embodiments, the storage battery system of the present embodiment cannot be based on a result of detection by state detection circuit 21 to avoid commitment of an abnormal storage battery board. However, as well as the first to third embodiments, the storage battery system according to the present embodiment can avoid commitment of a storage battery board in a failed state based on availability determination circuit 23. If a determination of a failure state based on availability determination circuit 23 alone suffices, state detection circuit 21 may be dispensed with in the control device, as in the present embodiment.

Note that the present embodiment as well as the third embodiment may use availability determination circuit 23B instead of availability determination circuit 23.

### Fifth Embodiment

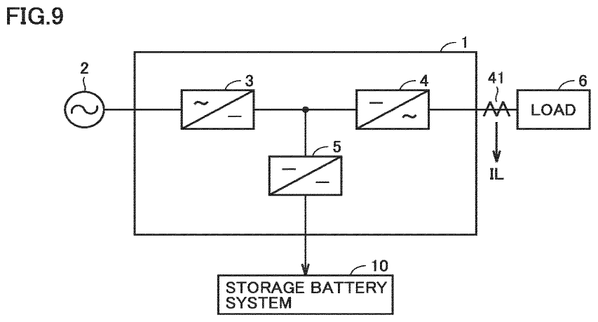

FIG. 9 is a diagram illustrating a configuration of a power supply system according to a fifth embodiment. The power supply system comprises an ammeter 41 provided on a wiring between uninterruptible power supply device 1 and load 6.

Ammeter 41 detects a magnitude of a load current IL flowing from uninterruptible power supply device 1 to load 6. The magnitude of load current IL represents a magnitude of load 6. The larger load current IL is, the larger load 6 is.

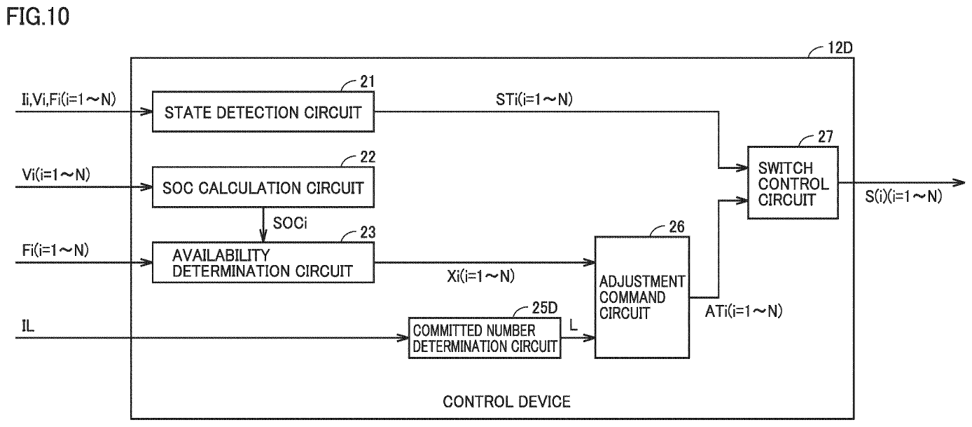

FIG. 10 is a functional block diagram of a control device 12D according to the fifth embodiment. Control device 12D according to the fifth embodiment is different from control device 12 according to the first embodiment in that control device 12D according to the fifth embodiment dispenses with system discharge current calculation circuit 24 and comprises a committed number determination circuit 25D instead of committed number determination circuit 25.

Committed number determination circuit 25D determines number L of storage battery boards to be committed based on load current IL. As load current IL increases, committed number determination circuit 25D may increase stepwise the number of storage battery boards to be committed.

Thus, according to the present embodiment, the magnitude of load 6 can be detected based on load current IL rather than a system discharge current.

It should be understood that the embodiments disclosed herein are illustrative and non-restrictive in any respect. The scope of the present invention is defined by the terms of the claims rather than the foregoing description, and is intended to encompass any modification falling within the meaning and scope equivalent to the terms of the claims.

### REFERENCE SIGNS LIST

1 uninterruptible power supply device, 2 AC input power source, 3 converter, 4 inverter, 5 chopper circuit, 6 load, 10 storage battery system, 11 storage battery monitoring board, 12, 12A, 12B, 12C, 12D, 12E control device, 13 storage battery board, 21 state detection circuit, 22 SOC calculation circuit, 23, 23B availability determination circuit, 24 system discharge current calculation circuit, 25, 25D committed number determination circuit, 26, 26A adjustment command circuit, 27, 27C switch control circuit, 31 commitment time counter, 41 ammeter, 51 current detector, 52 CMU, 53 BMU, BT lithium ion battery, CL cell, SW switch.

1. A storage battery system comprising:
a plurality of storage battery boards; and
a control device that controls the plurality of storage battery boards,
wherein the storage battery board includes a switch to control connection between the storage battery board and a power supply device,
wherein in response to a power failure caused as power supplied to the power supply device from an external power source is interrupted, the control device controls the switch of the plurality of storage battery boards based on a magnitude of a load connected to the power supply device, and
wherein the control device calculates as the magnitude of the load connected to the power supply device a sum in magnitude of currents flowing from the plurality of storage battery boards to the power supply device.

2. (canceled)

3. The storage battery system according to claim 1, wherein the control device determines, based on the sum in magnitude of currents flowing from the plurality of storage battery boards to the power supply device, a first number which is a number of storage battery boards to be connected to the power supply device in response to the power failure, and calculates a second number which is a total number of available storage battery boards,
wherein the control device determines the second number of any storage battery boards from available storage battery boards as storage battery boards to be held committed and determines any other storage battery boards as storage battery boards which is not to be held committed when the second number is equal to or larger than the first number, and
wherein the control device determines all storage battery boards as storage battery boards to be held committed when the second number is smaller than the first number.

4. The storage battery system according to claim 3, wherein the control device increases the number of storage battery boards to be connected to the power supply device in response to the power failure stepwise as the magnitude of the load increases.

5. The storage battery system according to claim 3, wherein the control device determines a storage battery board to be connected to the power supply device in response to the power failure based on an SOC of the storage battery board within a range of the first number.

6. The storage battery system according to claim 5, wherein the control device connects a storage battery board having an SOC equal to or larger than a threshold value to the power supply device within the range of the first number.

7. The storage battery system according to claim 3, wherein the control device determines a storage battery board to be connected to the power supply device in response to the power failure based on a history of connection between the storage battery board and the power supply device in response to a previous power failure within a range of the first number.

8. The storage battery system according to claim 7, wherein the control device determines a storage battery board to be connected to the power supply device in response to the power failure based on a cumulative value of time of connection between the storage battery board and the power supply device in response to a previous power failure within the range of the first number.

9. The storage battery system according to claim 5, wherein the control device determines a normal one of storage battery boards as a storage battery board to be connected to the storage battery board in response to the power failure.

10. The storage battery system according to claim 1, wherein the power supply device is an uninterruptible power supply device.

11. The storage battery system according to claim 1, wherein the storage battery board includes a lithium ion battery.

12. The storage battery system according to claim 3, wherein the power supply device is an uninterruptible power supply device.

13. The storage battery system according to claim 4, wherein the power supply device is an uninterruptible power supply device.

14. The storage battery system according to claim 5, wherein the power supply device is an uninterruptible power supply device.

15. The storage battery system according to claim 6, wherein the power supply device is an uninterruptible power supply device.

16. The storage battery system according to claim 7, wherein the power supply device is an uninterruptible power supply device.

17. The storage battery system according to claim 8, wherein the power supply device is an uninterruptible power supply device.

18. The storage battery system according to claim 9, wherein the power supply device is an uninterruptible power supply device.

19. The storage battery system according to claim 3, wherein the storage battery board includes a lithium ion battery.

20. The storage battery system according to claim 4, wherein the storage battery board includes a lithium ion battery.

21. The storage battery system according to claim 5, wherein the storage battery board includes a lithium ion battery.
